(19) United States
(12) Patent Application Publication
(10) Pub. No.: US 2015/0123762 A1
(43) Pub. Date: May 7, 2015

(54) METHOD AND SYSTEM OF OPENING AND CLOSING DOOR OF VEHICLE

(71) Applicant: HYUNDAI MOTOR COMPANY, Seoul (KR)

(72) Inventors: Sung Min PARK, Seoul (KR); Hui Sung LEE, Gunpo-Si (KR); Kwang Myung OH, Daejeon (KR); Sung Jin SAH, Suwon-Si (KR)

(21) Appl. No.: 14/320,072

(22) Filed: Jun. 30, 2014

(30) Foreign Application Priority Data
Nov. 5, 2013 (KR) 10-2013-0133427

(51) Int. Cl. G07C 9/00

(52) U.S. Cl. CPC G07C 9/00134
USPC 340/5.51

(57) ABSTRACT

A system of opening and closing a door of a vehicle includes a tap sensing type smart key configured to collect and transmit sensed information corresponding to tap pressure applied from the outside. A signal transmitter is configured to support transmission of the collected sensed information or a message corresponding to the sensed information.

### CROSS-REFERENCE TO RELATED APPLICATION

This application is based on and claims the benefit of priority to Korean Patent Application No. 10-2013-0133427, filed on Nov. 5, 2013 in the Korean Intellectual Property Office, the disclosure of which is incorporated herein in its entirety by reference.

### TECHNICAL FIELD

The present disclosure relates to opening and closing a vehicle door, and more specifically, to a method and a system of opening and closing a vehicle door capable of supporting the opening and closing of the vehicle door according to recognition of tapping of a smart key.

### BACKGROUND

Generally, a vehicle includes at least two doors. A driver opens and closes the doors of the vehicle using a key. According to the related art, the driver directly inserts the vehicle key into a key box provided in the door and rotates the key in a certain direction to open and lock the vehicle. However, when opening and closing the vehicle door according to the related art as described above, the driver needs to directly approach the vehicle and then operates the key into the key box. Therefore, it is difficult to perform the opening and closing operations of the vehicle door when the vehicle is relatively far.

In order to solve this problem, according to the related art, an electronic device is provided in the key box of the vehicle to allow the key box of the vehicle to be operated at a long distance using a smart key. Therefore, the driver may control the vehicle door to be opened and closed at the long distance without approaching the vehicle.

In a method of opening and closing the door using a smart key according to the related art, the driver needs to take the smart key out of a place at which the smart key is stored, for example, his/her pocket, or the like, in order to use the smart key, which is inconvenient. Further, in a situation in which the smart key is inserted into a wallet, it is also inconvenient. Since a user needs to take the wallet out of his/her pocket, open the wallet, and take the smart key out of the wallet in order to use the smart key, it is complicated to use the smart key. Further, when the driver does not continuously use his/her hand freely since it is difficult for the driver to grasp or operate the smart key, he/she may still complain about difficulty in opening and closing the vehicle door.

### SUMMARY

The present disclosure has been made to solve the above-mentioned problems occurring in the prior art while advantages achieved by the prior art are maintained intact.

An aspect of the present disclosure provides a method and a system of opening and closing a vehicle door capable of supporting more simple, easy, and rapid opening and closing of the vehicle door.

According to an exemplary embodiment of the present disclosure, a tap sensing type smart key includes a tap sensor configured to collect sensed information corresponding to at least one of pressure and audio signals depending on a tap operation applied from the outside. A signal transmitter is configured to support transmission of the collected sensed information or a message (or command) corresponding to the sensed information.

The tap sensing type smart key may further include a card shaped case configured to accommodate the tap sensor and the signal transmitter therein.

The tap sensor may sense set pressure patterns or audio patterns depending on tap operations generated at an outer portion of an object into which the card shaped case is inserted.

The tap sensor may be activated at the time of receiving a scan signal from a vehicle within a reference distance between the vehicle and the smart key.

According to another exemplary embodiment of the present disclosure, a vehicle supporting opening of a door includes a signal transceiver configured to receive sensed information corresponding to at least one of pressure patterns and audio patterns due to tap operations generated in the vicinity of an environment in which a tap sensing type smart key is disposed. A controller is configured to open and close at least one door depending on the received sensed information. A door opener/closer is configured to support the opening and closing of the door depending on a control of the controller.

The signal transceiver may transmit a signal for scanning the tap sensing type smart key at a set period of time or in real time.

The signal transceiver may receive a message (or command) requesting the opening of the door at a specific position from the tap sensing type smart key.

The controller may open the door corresponding to the message.

The controller may compare the sensed information with a reference signal and open and close the door depending on the sensed information in the case in which the sensed information is valid.

The controller may compare the sensed information with a plurality of reference signals and open and close at least one door depending on a kind of reference signals that are equal or similar to each other.

The controller may open and close only a driver's side door, open and close all doors, or open and close a trunk door depending on the sensed information.

According to another exemplary embodiment of the present disclosure, a system of opening and closing a door of a vehicle includes a tap sensing type smart key configured to collect and transmit sensed information corresponding to at least one of pressure patterns and audio patterns due to tap operations generated in the vicinity thereof. A vehicle is configured to perform a control to open and close at least one door depending on the sensed information received from the tap sensing type smart key.

According to another exemplary embodiment of the present disclosure, a method of opening and closing a vehicle door includes receiving a tap signal from a tap sensing type smart key, the tap signal corresponding to at least one of pressure patterns and audio patterns due to tap operations within a reference distance from a point in which a vehicle is positioned. At least one door is opened and closed by the vehicle depending on the tap signal.

The method may further include comparing, by the vehicle, the tap signal with a reference signal, wherein the opening and closing of the at least one door includes opening and closing the at least one door depending on similarity between the tap signal and the reference signal.

The method may further include comparing, by the vehicle, the tap signal with a plurality of reference signals, wherein the opening and closing of the at least one door includes opening and closing the at least one door depending on a reference signal that is equal or similar to the tap signal.

The opening and closing of the at least one door may include at least one of opening and closing only a driver's side door depending to the reference signal, opening and closing only all doors of the vehicle depending to the reference signal, and opening and closing only trunk door of the vehicle depending to the reference signal.

### BRIEF DESCRIPTION OF THE DRAWINGS

The above and other objects, features and advantages of the present disclosure will be more apparent from the following detailed description taken in conjunction with the accompanying drawings.

FIG. 1 is a drawing schematically showing a configuration of a system of opening and closing a vehicle door according to an exemplary embodiment of the present disclosure.

FIG. 2 is a block diagram showing a configuration of a tap sensing type smart key in the configuration of the system of opening and closing a vehicle door according to an exemplary embodiment of the present disclosure in more detail.

FIG. 3 is a diagram showing a configuration of the vehicle in the configuration of the system of opening and closing a vehicle door according to an exemplary embodiment of the present disclosure in more detail.

FIG. 4 is a diagram for describing a method of operating a tap sensing type smart key in a method of opening and closing a vehicle door according to an exemplary embodiment of the present disclosure.

FIG. 5 is a diagram for describing a method of operating a vehicle in the method of opening and closing a door of a vehicle according to an exemplary embodiment of the present disclosure.

### DETAILED DESCRIPTION

Hereinafter, exemplary embodiments of the present disclosure will be described in more detail with reference to the accompanying drawings. In describing the exemplary embodiments of the present disclosure, a description of technical contents that are well-known in the art to which the present disclosure pertains and are not directly related to the present disclosure will be omitted if possible. The reason why an unnecessary description is omitted is to make the gist of the present disclosure clear.

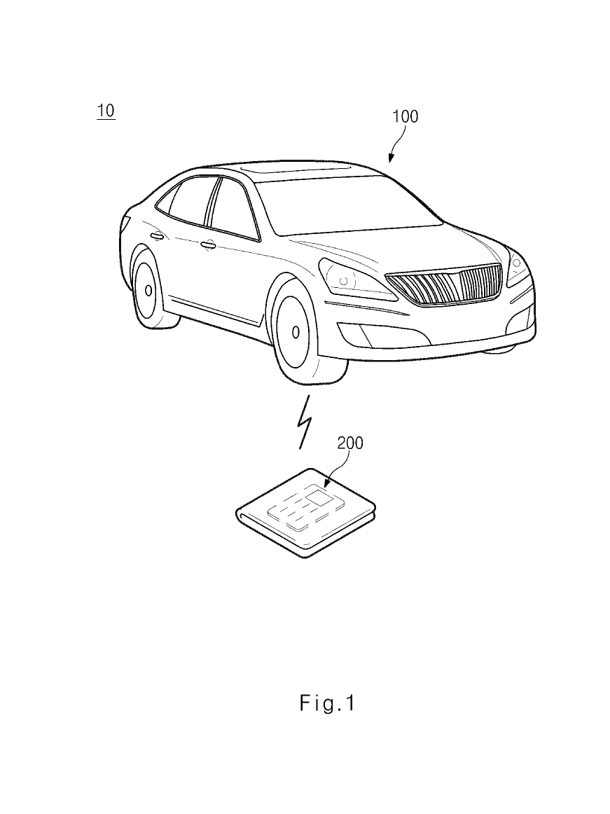

FIG. 1 is a drawing schematically showing a configuration of a system of opening and closing a vehicle door according to an exemplary embodiment of the present disclosure. Referring to FIG. 1, a system 10 of opening and closing a vehicle door according to an exemplary embodiment of the present disclosure may include a vehicle 100 and a tap sensing type smart key 200.

The system 10 of opening and closing the vehicle door according to an exemplary embodiment of the present disclosure having the above-mentioned configuration may allow the vehicle 100 to open at least one door thereof in the case in which the tap sensing type smart key 200 receives at least one of pressure and sound corresponding to a set tap pattern within a reference distance based on a position (for example, a distance between the vehicle and the smartkey) of the vehicle 100. The system 10 of opening and closing a vehicle door having the above-mentioned configuration may allow the vehicle 100 to automatically open the door thereof in the case in which a tap operation is applied to the tap sensing type smart key 200 even though the tap sensing type smart key 200 is not taken out of a pocket in which the tap sensing type smart key 200 is stored, or the like, or is not grasped in order to open and close the door of the vehicle 100. Therefore, the system 10 of opening and closing a vehicle door according to an exemplary embodiment of the present disclosure may allow a smart key to be operated even though a driver does not take the smart key out of his/her pocket, after he/she puts the smart key in his/her pocket or the like. As a result, the system 10 of opening and closing a vehicle door according to an exemplary embodiment of the present disclosure may allow the driver to simply and rapidly open the door of the vehicle 100. In addition, in an exemplary embodiment of the present disclosure, the door of the vehicle 100 is not opened by simply positioning the smart key within the reference distance of the vehicle 100, thereby preventing various crimes such as stealing, theft, and the like. In addition, the system 10 of opening and closing a door of a vehicle according to an exemplary embodiment of the present disclosure may allow the tap sensing type smart key 200 to be operated even in a state in which the tap sensing type smart key 200 is stored and may allow only a specific door to be opened depending on the operation of the smart key.

The vehicle 100 may include at least one door. For example, the vehicle 100 may include a driver's side door through which the driver gets on and gets off the vehicle and a passenger's side door. The vehicle 100 may include a rear door. Here, the rear door may be a trunk door. In addition, the vehicle 100 may have various shapes such as a shape in which it has four doors, a shape in which it has three doors, or the like, depending on a manufacturing shape. The vehicle 100 according to an exemplary embodiment of the present disclosure may include a door opener/closer disposed at one side of the door. The door opener/closer may be opened and closed depending on a control of a controller 120 of the vehicle 100.

The tap sensing type smart key 200 may sense a set pattern of pressure, a set pattern of tap sound, or the like, which are generated depending on a tap operation of a user. The tap sensing type smart key 200 may transmit a message, sensing information, or a command corresponding to the set pattern of pressure sensed depending on the tap operation or the set pattern of tap sound generated by the tap operation to the vehicle 100. The tap sensing type smart key 200 may also be manufactured in a shape in which it is relatively thin and wide, for example, a business card shape, in order to more clearly and more easily recognize the tap operation, or the like, of the user. Therefore, the tap sensing type smart key 200 may be provided in a shape in which it may sense pressure or sound depending on a tap operation generated from the outside even though it is stored in an inner pocket, a back pocket, or the like, of the user.

As described above, the system 10 of opening and closing a door of a vehicle according to an exemplary embodiment of the present disclosure senses external pressure or sound corresponding to the tap operation, or the like, of the user based on the tap sensing type smart key 200, thereby controlling the opening and closing of the door of the vehicle 100. Here, the above-mentioned respective components will be described in more detail with reference to the accompanying drawings.

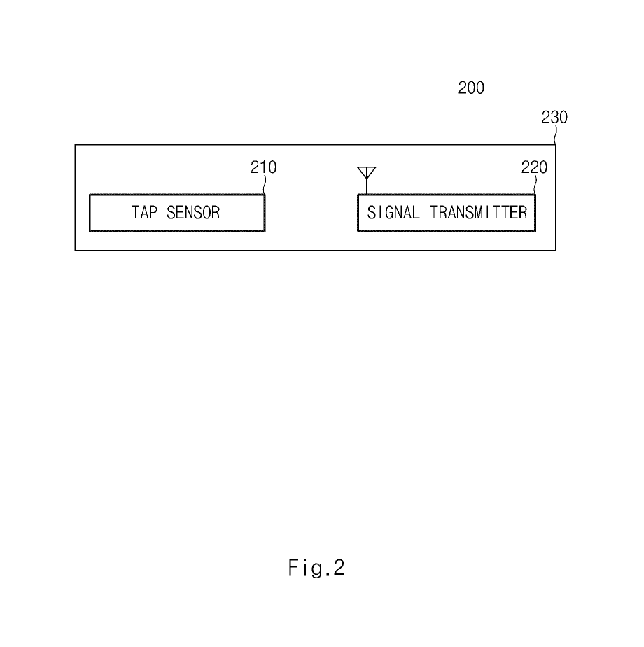

FIG. 2 is a block diagram showing a configuration of a tap sensing type smart key in the configuration of the system of opening and closing a vehicle door according to an exemplary embodiment of the present disclosure in more detail. Referring to FIG. 2, the tap sensing type smart key 200 according to an exemplary embodiment of the present disclosure may include a tap sensor 210, a signal transmitter 220, and a case 230.

The tap sensor 210 may sense a pressure change applied from the outside. The tap sensor 210 may sense, for example, the pressure change or a pressure pattern change corresponding to a tap operation. Alternatively, the tap sensor 210 may sense an audio signal in a set frequency band or a set pattern of audio signal generated depending on the tap operation. The tap sensor 210 according to an exemplary embodiment of the present disclosure may be a sensor capable of sensing at least one of pressure and audio signals depending on a finger tap or a hand tap of the user, a tap operation using a specific object, or the like, applied to the tap sensing type smart key 200. The tap sensor 210 may also be configured in a form in which a plurality of tap sensors are disposed in a reference area in order to improve accuracy in sensing the tap. The tap sensor 210 may transfer sensed information depending on generation of the tap to the signal transmitter 220. The tap sensor 210 may be provided in various forms such as an active element, a passive element, or the like. In the case in which the tap sensing type smart key 200 has a separate power supply, the tap sensor 210 may be formed of the passive element. In addition, in the case in which the tap sensing type smart key 200 includes a coil collecting power, the tap sensor 210 may be formed of the passive element. In the case in which the tap sensing type smart key 200 does not have the separate power supply, the tap sensor 210 may be formed of the active element. In this case, the tap sensor 210 may generate an electrical change in the case in which pressure is applied from the outside thereto and may transfer the corresponding electrical change to the signal transmitter 220. The tap sensor 210 may be in an inactive state or a standby state, receive a scan signal transmitted by the vehicle 100 at a reference point at which the vehicle 100 is positioned, and be activated due to reception of the corresponding signal.

The signal transmitter 220 may transmit the sensed information collected by the tap sensor 210 to the vehicle 100. Alternatively, the signal transmitter 220 may transmit a vehicle door opening request message corresponding to the sensed information provided by the tap sensor 210 to the vehicle 100.

The case 230 may be manufactured in a card shape in which front and rear surfaces thereof have a reference area and a side surface thereof is relatively thin. The card shaped case 230 may accommodate the tap sensor 210 and the signal transmitter 220 described above therein. The card shaped case 230 may be inserted into or be put in a specific object, for example, a wallet, a pocket, or the like. Therefore, the tap sensor 210 mounted in the card shaped case 230 may collect pressure patterns or audio patterns depending on tap operations applied from the outside of the wallet or the pocket.

According to various exemplary embodiments, the tap sensing type smart key 200 may collect various patterns of sensed information depending on various tap operations. For example, the tap sensing type smart key 200 may collect the pressure patterns corresponding to various pressure changes and the audio signal patterns corresponding to various audio signal changes. In addition, various patterns of sensed information transferred to the vehicle 100 by the tap sensing type smart key 200 may be used as various valid functions depending on a pre-designed scheme. For example, a first pattern of sensed information transferred by the tap sensing type smart key 200 may be used as a signal requesting the opening of all doors of the vehicle 100. In addition, a second pattern of sensed information transferred by the tap sensing type smart key 200 may be used as a signal requesting the opening of only a trunk door of the vehicle 100. Further, a third pattern of sensed information transferred by the tap sensing type smart key 200 may be used as a signal requesting the opening of only a driver's side door of the vehicle 100.

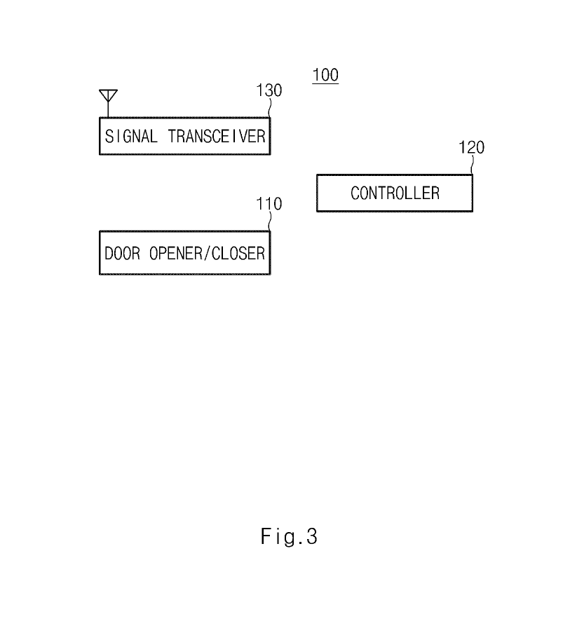

FIG. 3 is a diagram showing a configuration of a vehicle in the configuration of the system of opening and closing a door of a vehicle according to an exemplary embodiment of the present disclosure in more detail. Referring to FIG. 3, the vehicle 100 according to an exemplary embodiment of the present disclosure may include a signal transceiver 130, a door opener/closer 110, and a controller 120.

The signal transceiver 130 may receive sensed information or a message from the tap sensing type smart key 200. The signal transceiver 130 may scan the circumference of the vehicle in real time or at a set period of time depending on a control of the controller 120. The signal transceiver 130 may receive identification information from the tap sensing type smart key 200 when the tap sensing type smart key 200 is sensed. In the case in which the identification information provided by the tap sensing type smart key 200 is predefined identification information, the controller 120 may control processing on the sensed information or the message provided by the tap sensing type smart key 200.

When the tap sensing type smart key 200 is searched through the signal transceiver 130, the controller 120 may prepare to receive the message or the sensed information from the tap sensing type smart key 200. In addition, the controller 120 may confirm whether a specific pattern of sensed information is a valid signal when the specific pattern of sensed information is transferred from the tap sensing type smart key 200. To this end, the controller 120 may operate reference information for judging validity of the sensed information. The reference information may be predefined and stored.

The controller 120 of the vehicle 100 may support a key setting process based on the tap sensing type smart key 200. The controller 120 may provide a key setting menu of the tap sensing type smart key 200. When a corresponding menu is selected, the controller 120 may match a reference pattern input from the tap sensing type smart key 200 and opening of a specific door to each other. For example, the controller 120 may match the first pattern and opening of the driver's side door to each other. The controller 120 may match the second pattern and opening of the trunk door to each other. The controller 120 may match the third pattern and opening of all doors to each other. Here, the controller 120 may store the first to third patterns and then perform a comparison process between the first to third patterns and patterns input from the tap sensing type smart key 200.

In the case in which a predefined message corresponding to the specific pattern of sensed information is received from the tap sensing type smart key 200, the controller 120 may perform a function control corresponding to the message without performing a separate signal comparison process. For example, when the controller 120 receives a message requesting the opening of the driver's side door from the tap sensing type smart key 200, it may open the driver's side door depending on the message. Similarly, when the controller 120 receives a message requesting the opening of all doors from the tap sensing type smart key 200, it may open all doors depending on the message.

The door opener/closer 110 opens and closes at least one door depending on the control of the controller 120. The door opener/closer 110 may include a device opening and closing the trunk door and a device opening and closing other doors. Here, the device opening and closing other doors may also be designed so as to individually open and close the respective doors. Particularly, the door opener/closer 110 may be designed so as to independently open and close the driver's side door. Therefore, the door opener/closer 110 may individually open or lock the trunk door, the driver's side door, a passenger's side door, a rear door, and the like, depending on the control of the controller 120. Alternatively, the door opener/closer 110 may open or lock all doors at a time depending on the control of the controller 120.

Although a form in which the door of the vehicle 100 is opened depending on the control of the controller 120 has been mainly described above, the present disclosure is not limited thereto. For example, when a specific pattern of sensed information is generated from the tap sensing type smart key 200 within a reference distance based on a point at which the vehicle 100 is positioned and is transferred to the vehicle 100, the vehicle 100 may lock the door depending on the corresponding sensed information. In this case, the controller 120 of the vehicle 100 may have a reference pattern for locking the door and may compare a signal provided from the tap sensing type smart key 200 with the reference pattern to control the locking of the door. Alternatively, the reference pattern applied in a process in which the driver's side door is changed from a locked state into an opened state may be similarly to a process in which the driver's side door is changed from the opened state into the locked state depending on a toggle scheme operation. For example, the first pattern of sensed information may be similarly applied to the opening or locking of the driver's side door depending on the opening or locking of the door. Alternatively, the first pattern of sensed information may be applied to the opening of the driver's side door or the locking of all doors.

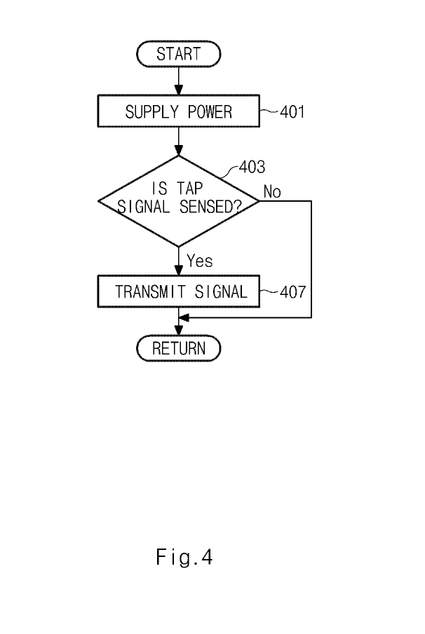

FIG. 4 is a diagram for describing a method of operating a tap sensing type smart key in a method of opening and closing a vehicle door according to an exemplary embodiment of the present disclosure.

Referring to FIG. 4, in the method of operating a tap sensing type smart key according to an exemplary embodiment of the present disclosure, power may be first supplied to the tap sensing type smart key 200 in step 401. For example, the tap sensing type smart key 200 may include a coil for a scan signal reaction or a wireless power reaction and may receive and recognize a scan signal or wireless power from the vehicle 100 in the case in which it enters a reference distance based on a point at which the vehicle 100 is positioned. Alternatively, in the case in which the tap sensing type smart key 200 has a separate power supply, it may have a standby state for recognizing a tap operation.

Next, the tap sensing type smart key 200 may confirm whether or not a tap signal has been sensed depending on the tap operation in step 403. Here, the tap signal may include at least one of a pressure change depending on the tap operation and an audio signal change generated by the tap operation. When the tap signal is sensed in step 403, the tap sensing type smart key 200 may be branched into step 407 to transmit a signal. That is, the tap sensing type smart key 200 may transfer the signal to the vehicle 100. In this case, the tap sensing type smart key 200 may transfer the signal corresponding to the sensed information to the vehicle 100 or transfer a message depending to the sensed information to the vehicle 100.

The tap sensing type smart key 200 may skip step 407 in the case in which the tap signal is not sensed in step 403. Then, the tap sensing type smart key 200 may be branched into a process before step 403 to perform processes again after step 403.

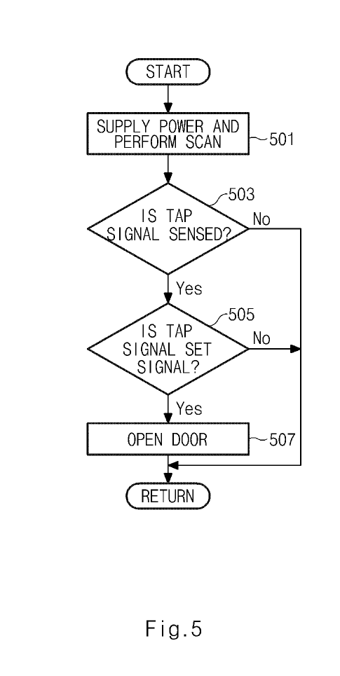

FIG. 5 is a diagram for describing a method of operating a vehicle in the method of opening and closing a vehicle door according to an exemplary embodiment of the present disclosure. Referring to FIG. 5, in the method of operating a vehicle according to an exemplary embodiment of the present disclosure, the controller 120 of the vehicle 100 may first perform a power supplying and scanning process in step 501. In this case, the controller 120 may supply the power to the signal transceiver 130 and scan on the tap sensing type smart key 200 at a set period of time or in real time.

The controller 120 may configure whether or not a tap signal has been received from the tap sensing type smart key 200 in step 503. When a separate tap signal is not received in step 503, the controller 120 may skip step 505 and step 507 and return to step 501. When the tap signal is received from the tap sensing type smart key 200 in step 503, the controller 120 may be branched into step 505 to confirm whether or not the corresponding tap signal is a set signal. To this end, the controller 120 may compare the received tap signal with a reference signal. Here, the reference signal may be a signal that is previously input in order to determine the opening and closing of the vehicle door. This reference signal may be input or corrected by the user as described above.

In the case in which the tap signal is not the set signal in step 505, the controller 120 may skip step 507 and be branched into a process before step 501 to perform processes again after step 501. In addition, in the case in which the tap signal is the set signal in step 505, the controller 120 may be branched into step 507 to open the door. In this case, the controller 120 may open at least some of the doors depending on a kind of tap signals. After the door is opened, the controller 120 may stop the power supplying and scanning process and stop the process of controlling the opening and closing of the vehicle door. In step 507, the controller 120 may open only a specific door or all doors depending on a pre-designed scheme.

Although the case in which the comparison of the set signal and the control of the opening and closing of the door depending on the comparison are performed in the vehicle 100 has been described above by way of example, the present disclosure is not limited thereto. That is, as described above, in the case in which a message requesting the opening of a specific door or the locking of the specific door is received from the tap sensing type smart key 200, the controller 120 may open or close the door of the vehicle 100 depending on the corresponding message. In this process, the controller 120 may omit a separate signal comparison process.

As described above, the method and the system of opening and closing a door of a vehicle according to an exemplary embodiment of the present disclosure may support generation of a signal for opening and closing in various environments such as when the user may not completely use his/her two hands, or when it is difficult to easily take the smart key out of a user's pocket.

As set forth above, the present disclosure may allow a key to be used to open and close the vehicle door without taking the key out of a specific storing place in the process of controlling the opening and closing of the vehicle door.

In addition, the present disclosure may allow a signal for opening and closing the vehicle door to be generated without directly grasping the key.

Further, the present disclosure may allow only a specific door to be opened depending on a control of the user, thereby providing a system capable of actively coping with crimes.

Although the exemplary embodiments of the present disclosure have been illustrated in the present specification and the accompanying drawings and specific terms have been used, they are used in a general meaning in order to assist in the understanding the present disclosure and do not limit the scope of the present disclosure. It will be obvious to those skilled in the art to which the present disclosure pertains that other modifications based on the spirit of the present disclosure may be made, in addition to the above-mentioned exemplary embodiments.

What is claimed is:

1. A tap sensing type smart key comprising:
a tap sensor configured to collect sensed information corresponding to at least one of pressure and audio signals depending on a tap operation applied from the outside; and
a signal transmitter configured to support transmission of the collected sensed information or a message corresponding to the sensed information.

2. The tap sensing type smart key according to claim 1, further comprising a card shaped case configured to accommodate the tap sensor and the signal transmitter therein.

3. The tap sensing type smart key according to claim 2, wherein the tap sensor senses set pressure patterns or audio patterns depending on tap operations generated at an outer portion of an object into which the card shaped case is inserted.

4. The tap sensing type smart key according to claim 1, wherein the tap sensor is activated at the time of receiving a scan signal from a vehicle within a set distance between the vehicle and the smart key.

5. A vehicle supporting opening of a door, comprising:
a signal transceiver configured to receive sensed information corresponding to at least one of pressure patterns and audio patterns, wherein the at least one of pressure patterns and audio patterns are generated where a tap sensing type smart key is disposed;
a controller configured to open and close at least one door depending on the received sensed information; and
a door opener/closer configured to support the opening and closing of the door depending on a control of the controller.

6. The vehicle according to claim 5, wherein the signal transceiver transmits a signal for scanning the tap sensing type smart key at a set period of time or in real time.

7. The vehicle according to claim 5, wherein the signal transceiver receives a command requesting to open the door of a specific position from the tap sensing type smart key.

8. The vehicle according to claim 7, wherein the controller opens the door corresponding to the command.

9. The vehicle according to claim 5, wherein the controller compares the sensed information with a reference signal and opens and closes the door depending on the sensed information in the case in which the sensed information is valid.

10. The vehicle according to claim 5, wherein the controller compares the sensed information with a plurality of reference signals and opens and closes at least one door depending on a kind of reference signals that are equal or similar to each other.

11. The vehicle according to claim 10, wherein the controller opens and closes only a driver's side door, opens and closes all doors, or opens and closes a trunk door depending on the sensed information.

12. A system of opening and closing a door of a vehicle, the system comprising:
a tap sensing type smart key configured to collect and transmit sensed information corresponding to at least one of pressure patterns and audio patterns due to tap operations generated in the vicinity thereof; and
a vehicle configured to open and close at least one door depending on the sensed information received from the tap sensing type smart key.

13. A method of opening and closing a vehicle door, the method comprising steps of:
receiving a tap signal from a tap sensing type smart key, the tap signal corresponding to at least one of pressure patterns and audio patterns due to tap operations within a reference distance from a point in which a vehicle is positioned; and
opening and closing, by the vehicle, at least one door depending on the tap signal.

14. The method according to claim 13, further comprising, comparing, by the vehicle, the tap signal with a reference signal,
wherein the opening and closing of the at least one door includes opening and closing the at least one door depending on similarity between the tap signal and the reference signal.

15. The method according to claim 13, further comprising, comparing, by the vehicle, the tap signal with a plurality of reference signals,
wherein the opening and closing of the at least one door includes opening and closing the at least one door depending on a reference signal that is equal or similar to the tap signal.

16. The method according to claim 15, wherein the step of opening and closing of the at least one door includes at least one of:
opening and closing only a driver's side door depending to the reference signal;
opening and closing only all doors of the vehicle depending to the reference signal; and
opening and closing only trunk door of the vehicle depending to the reference signal.
